(19) United States
(12) Patent Application Publication
(10) Pub. No.: US 2011/0185099 A1
(43) Pub. Date: Jul. 28, 2011

(54) Modular and Redundant Data-Storage Controller And a Method for Providing a Hot-Swappable and Field-Serviceable Data-Storage Controller

(75) Inventors: Jason M. Stuhlsatz, Dacula, GA (US); Macen Shinsato, Wichita, KS (US); Mohamad El-Batal, Westminster, CO (US)

(73) Assignee: LSI Corporation, Milpitas, CA (US)

(21) Appl. No.: 12/695,241

(22) Filed: Jan. 28, 2010

(51) Int. Cl. G06F 13/00; G06F 12/00; G06F 1/26; G06F 13/14

(52) U.S. Cl. 710/302; 711/114; 713/300; 711/E12.001; 710/305

(57) ABSTRACT

A modular and redundant storage controller system includes management modules, controller modules and an interconnect module. The management modules provide direct-current power and signals to respective controller modules. The controller modules include respective signal interfaces, direct-current interfaces, and interconnect interfaces. The signal interfaces couple the controllers to a respective management module. The direct-current interfaces couple the controllers to a respective management module. The interconnect module includes a pair of connectors arranged to couple a pair of the controller modules via the respective interconnect module interfaces.

### TECHNICAL FIELD

The present application relates generally to data-storage systems and, more particularly, to a modular and redundant data-storage controller system.

### BACKGROUND

A storage array or disk array is a data storage device that includes multiple disk drives or similar persistent storage units. A storage array can allow large amounts of data to be stored in an efficient manner. A storage array also can provide redundancy to promote reliability, as in the case of a Redundant Array of Inexpensive Disks (RAID) storage array.

The acronym “RAID” is an umbrella term for computer data-storage schemes that can divide and replicate data among multiple hard-disk drives. Various RAID designs involve two key design goals: increased data reliability and increased input/output performance. When several physical hard-disk drives are set up to use RAID technology, the hard-disk drives are said to be in a RAID array. The RAID array distributes data across several hard-disk drives, but the array is exposed to the operating system as a single logical disk drive.

In addition to the disk drives or other persistent storage units, a storage array commonly also includes an enclosure, power supply, one or more controllers (typically in the form of one or more circuit boards), and interfaces to connect the storage array to an external host, such as a computer or network device. The controller includes one or more processors or application specific logic that causes the storage array to read or write data to or from its persistent storage in response to requests received from an external host. A controller also commonly includes memory that acts as a buffer or temporary storage for data being transferred between the host and persistent storage. A controller further commonly includes host input/output (I/O) controllers (HICs) that interface the storage array controller with the host, and target I/O controllers (TICs) that interface the storage array controller with the disk drives or other persistent storage units.

Existing controller architectures include a controller board with TICs on the controller board. Consequently, a failed controller board necessitates the removal of target device interface cables before a failed controller board can be removed from the system. It is undesirable to provide a storage controller architecture that requires an operator to disconnect target device interface cables to remove or service a redundant storage controller. As a result, some existing solutions include a midplane to unify power, management, and data paths in a storage controller. When the midplane is centrally located, controllers, HICs, TICs, power supplies, and the like can be provided in redundant pairs and removed independently of the other components. Such redundancy makes it possible to separately remove and replace a failed device without taking the storage array offline. However, a centrally connected midplane is not serviceable or removable by a customer. In addition, a centrally located midplane is a non-redundant part, the failure of which can render an otherwise highly available system of redundant components inoperable.

### SUMMARY

An embodiment of a modular and redundant storage controller configured to operate a redundant array of inexpensive disks (RAID) includes redundantly configured management modules, controller modules and an interconnect module. The management modules include a first management panel with a management-signal interface and a management direct-current interface. The controller modules include an interface panel. The interface panel includes a controller-signal interface, a controller direct-current interface, and an interconnect module interface. The controller-signal interface electrically couples a respective controller module to a respective management-signal interface. The controller direct-current interface electrically couples a respective controller module to a respective management direct-current interface. The interconnect module includes a pair of connectors arranged to electrically couple the redundantly configured controller modules via the respective interconnect-module interfaces.

An embodiment of a method for providing a hot-swappable and field-serviceable storage controller includes the steps of, providing a pair of redundantly configured management modules each comprising a management-signal interface and a management direct-current interface, providing a pair of redundantly configured controller modules each comprising a controller-signal interface, a controller direct-current interface, and an interconnect interface, the interconnect interface having a data bus connection and a direct-current bus connection, providing an interconnect module comprising a pair of connectors, a pair of data buses, and a pair of direct-current buses, coupling a respective controller module to a respective management module via the controller signal interface and the management-signal interface, coupling a respective controller module to a respective management module via the controller direct-current interface and the management direct-current interface, and using the interconnect module to couple the respective data bus connection and the respective direct-current bus connection of the redundantly configured controller modules.

The figures and detailed description that follow are not exhaustive. The disclosed embodiments are illustrated and described to enable one of ordinary skill to make and use the storage controller. Other embodiments, features and advantages of the controller and methods will be or will become apparent to those skilled in the art upon examination of the following figures and detailed description. All such additional embodiments, features and advantages are within the scope of the controller and methods as defined in the accompanying claims.

### BRIEF DESCRIPTION OF THE FIGURES

The modular and redundant storage controller and a method for providing a hot-swappable and field-serviceable storage-controller can be better understood with reference to the following figures. The elements and features within the figures are not necessarily to scale, emphasis instead being placed upon clearly illustrating the principles for making and using the storage controller. Moreover, in the figures, like reference numerals designate corresponding parts throughout the different views.

FIG. 1 is a perspective front view illustrating an embodiment of a storage controller.

FIG. 2 is a perspective rear view of the storage controller of FIG. 1.

FIGS. 3A-3B are front and rear plan views respectively of the storage controller of FIG. 1.

FIG. 4 is a top plan view of the storage controller of FIG. 1.

FIGS. 5A-5B are front and rear perspective views respectively of an embodiment of a management module.

FIGS. 6A-6B are front and rear perspective views respectively of an embodiment of an interconnect module.

FIGS. 7A-7B are front and rear perspective views respectively of an embodiment of a power supply module.

FIGS. 8A-8B are front and rear perspective views respectively of an embodiment of a host input/output module.

FIGS. 9A-9B are front and rear perspective views respectively of an embodiment of a target input/output module.

FIG. 10 is a block diagram illustrating an embodiment of data paths within the storage controller of FIG. 1.

FIG. 11 is a block diagram illustrating an embodiment of direct-current buses within the storage controller of FIG. 1.

FIG. 12 is a partial front perspective view of an embodiment of the storage controller of FIG. 1.

FIG. 13 is a partial front perspective view of an alternative embodiment of the storage controller of FIG. 1.

FIG. 14 is a flow diagram illustrating an embodiment of a method for providing a hot-swappable and field-serviceable storage-controller system.

### DETAILED DESCRIPTION

A modular and redundant storage controller system includes management modules, controller modules, power supply modules, input/output modules and an interconnect module. The management modules provide alternating-current power to the power supply modules. The management modules provide direct-current power and signals to respective controller modules. In addition, the management modules include circuitry and connectors to enable network connectivity and one or more human to machine interfaces. The controller modules include respective signal interfaces, direct-current interfaces, and interconnect interfaces. The signal interfaces couple the controllers to a respective management module. The direct-current interfaces couple the controllers to a respective management module. The controller modules also interface with host input/output controllers (HICs) and target input/output controllers (TICs). The interconnect module includes a pair of connectors arranged to couple a pair of the controller modules via the respective interconnect module interfaces. The interconnect module provides data busses and a DC power connection to couple the respective controller modules to each other.

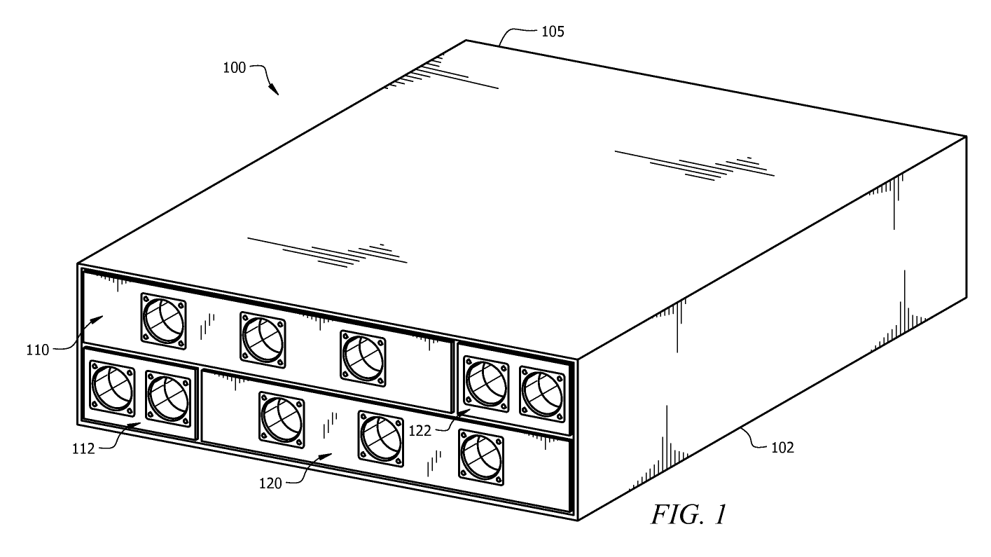

FIG. 1 is a perspective front view illustrating an embodiment of a storage controller 100. The storage controller 100 has a frontward facing opening and a rearward facing opening for receiving multiple frontward facing modules and multiple rearward facing modules. The storage controller 100 is about 19 inches (or about 480 mm) wide, not including a left-side flange and a right-side flange (not shown) with suitably arranged mounting holes for fastening the flanges to a standard equipment rack with screws. The storage controller 100 is about 5.16 inches (or about 131.1 mm) or 3 rack units (3U) high. The storage controller 100 is arranged in a housing 102 with a removable lid 105. The storage controller 100 includes removable and redundantly configured modules within the housing 102. The housing 102 has a left-side panel, a right-side panel and a bottom panel. The housing 102 is enclosed by a lid 105 that is arranged to closely contact the left-side and right-side panels. The removable and redundantly configured modules are electrically and mechanically removed from the storage controller 100 by pulling the modules away from the storage controller 100 in a plane substantially parallel to the bottom panel of the storage controller 100.

The storage controller 100 includes overlapping and offset controller modules as well as power supply modules. The offset controller modules and power supply modules are frontward facing modules. A first controller module 110 is arranged above and partially offset from a second controller module 120. A first power supply module 112 is located below the first controller module 110 and to the left of the second controller module 120. A second power supply 122 is located above the second controller module 120 and to the right of the first controller module 110. The first controller module 110 and the second controller module 120 are each arranged with multiple fans. Three fans are shown across the frontward face of each of the first controller module 110 and the second controller module 120. More or less than three fans may be provided in alternative embodiments of the controller modules. The first power supply 112 and the second power supply 122 are each arranged with two fans. More or less than two fans may be provided in alternative embodiments of the power supplies.

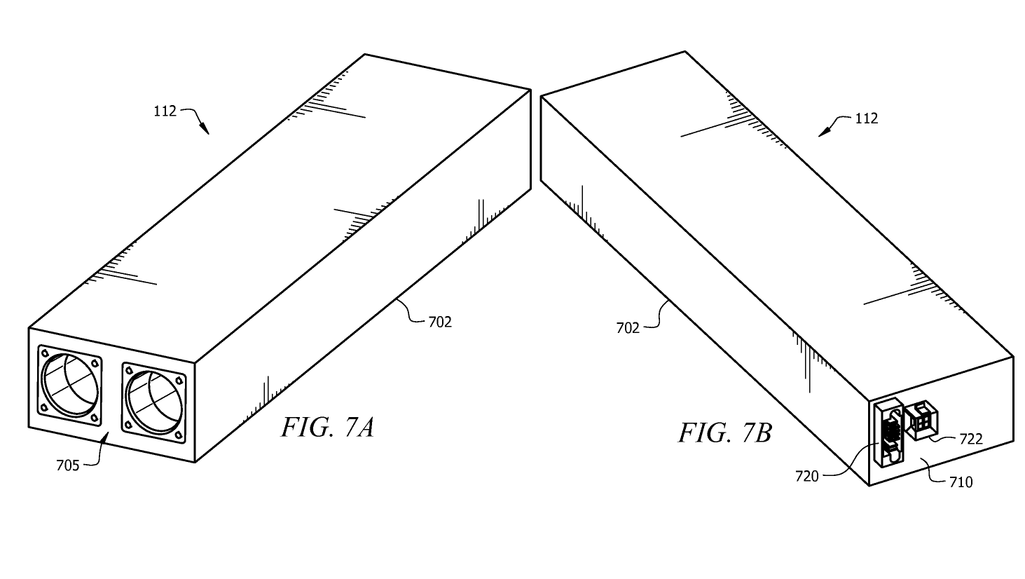

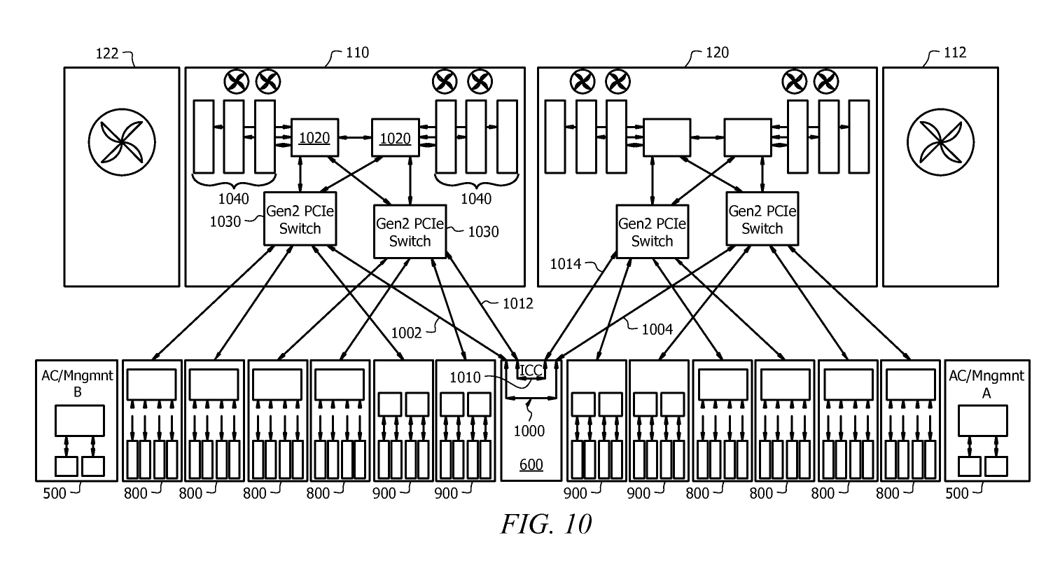

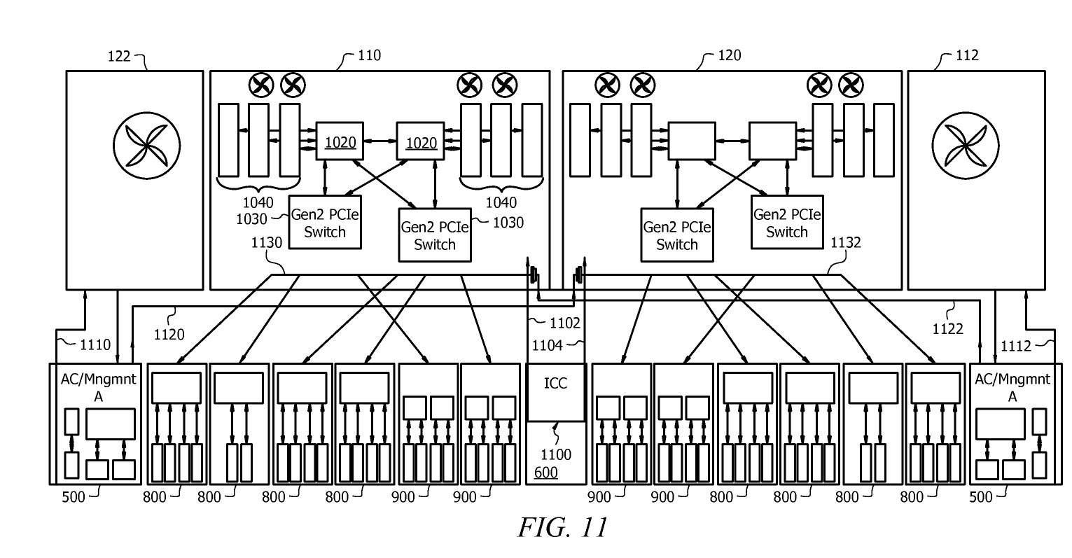

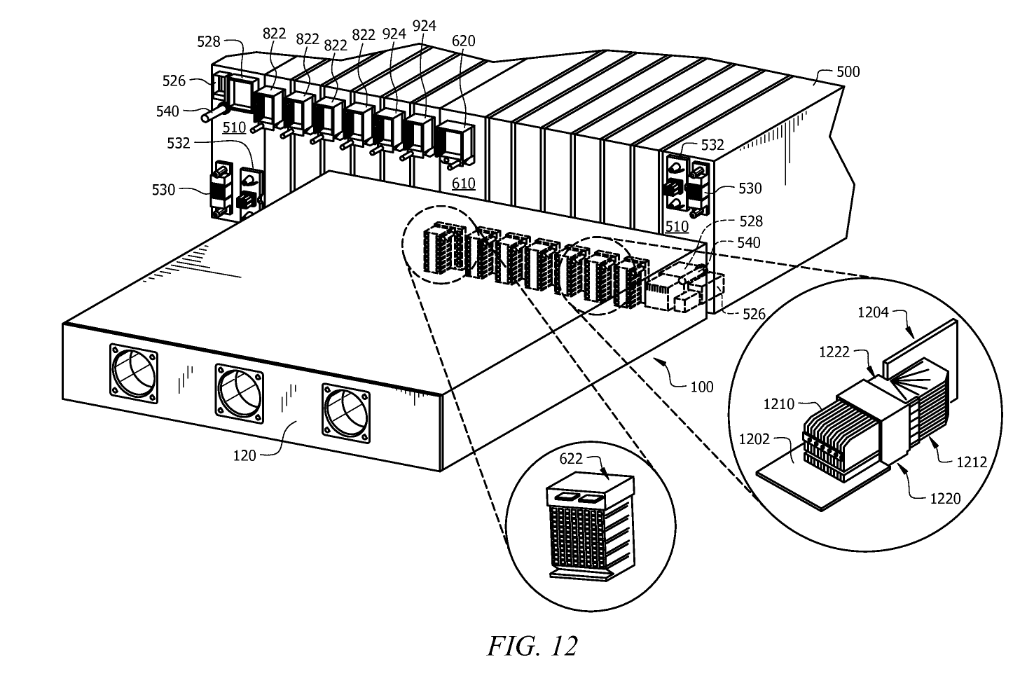

Internal features and functions provided by the first controller module 110 and the second controller module 120 will be described in association with the embodiments illustrated in FIGS. 10 and 11. External features such as connectors that enable electrical and physical connectivity between various other modules that obviate the need for a mid-plane element in the storage controller 100 are described in association with the embodiment illustrated in FIG. 12. External features of the power supply module 112 that enable physical and electrical connectivity with other modules that obviate the need for a mid-plane element in the storage controller 100 are described in association with the embodiment illustrated in FIG. 7B.

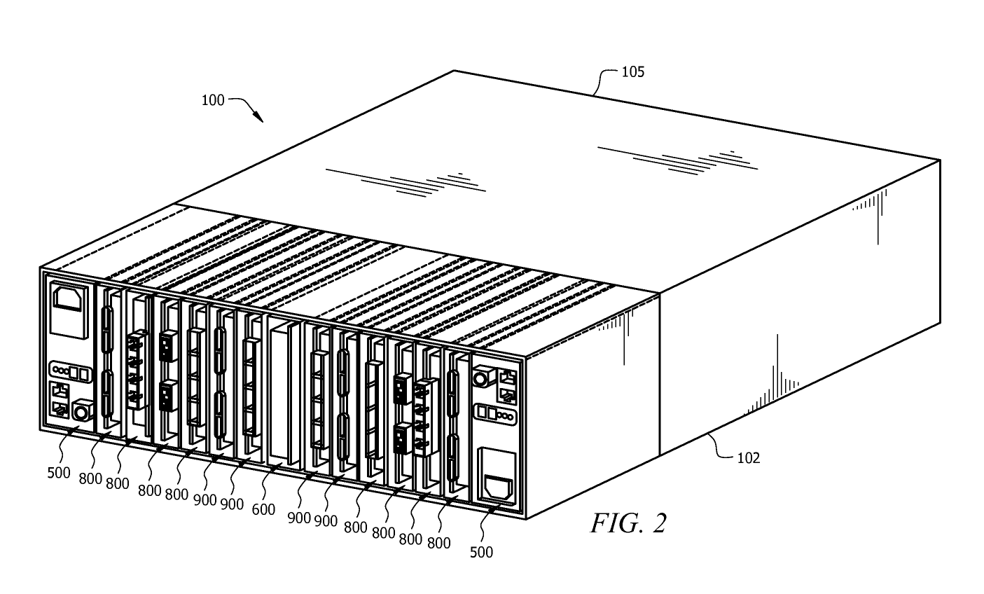

FIG. 2 is a perspective rear view of the storage controller 100 of FIG. 1. The storage controller 100 is illustrated in FIG. 2 with a portion of the lid 105 and a portion of a side panel removed from the housing 102 to reveal modules that are electrically and physically coupled to the power supply modules and the controller modules of FIG. 1. As shown, the various modules include from left to right a management module 500, four instances of host input/output controllers (HICs) 800, two instances of target input/output controllers (TICs) 900, a single interconnect module 600, two additional TICs 900, four additional HICs 800 and an additional management module 500. The management modules 500, HICs 800, TICs 900, and the interconnect module 600 are examples of rearward facing modules.

The management modules 500 include a first management panel and a second management panel opposed to the first management panel. The first management panel, which is hidden in the rear perspective view, includes a pair of connectors for coupling the management module 500 to a respective power supply module and a pair of connectors for coupling the management module 500 to a respective controller module. The second management panel, which is observable from the rear view of the storage controller 100, includes sockets and a display element. The sockets provide standard interfaces for receiving power, as well as signals from various input devices to enable operator interaction with the storage controller 100. The display element includes light-emitting diodes, lamps or other display elements to provide status information to an operator.

The HICs 800 and the TICs 900 are similarly arranged. That is, the HICs 800 and the TICs 900 are arranged with respective connectors that enable electrical and physical connectivity with a respective controller module. These respective connectors are hidden in the rear perspective view. The HICs 800 are arranged with respective connectors that enable electrical connectivity with a remote host via a cable. The TICs 900 are arranged with respective connectors that enable electrical connectivity with a target disk drive or other persistent storage device. Consequently, operator serviceable connections for power, operator input/output, as well as input/output to a host (e.g., a computer that accesses the stored data managed by the storage controller 100) or a target device (e.g., a physical disk drive) are arranged in the rearward facing opening in the housing 102.

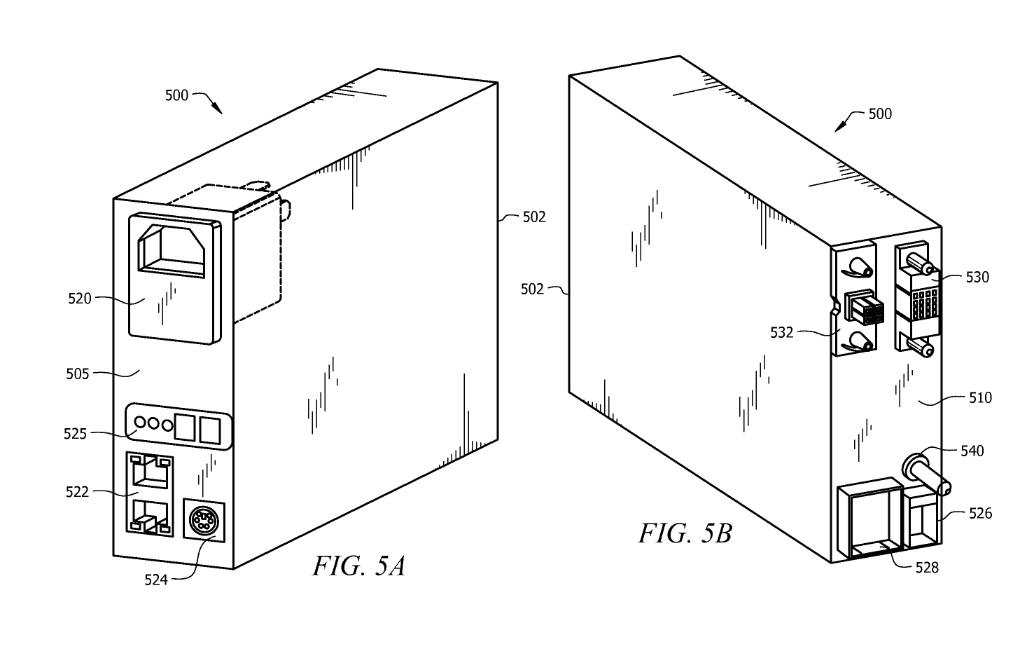

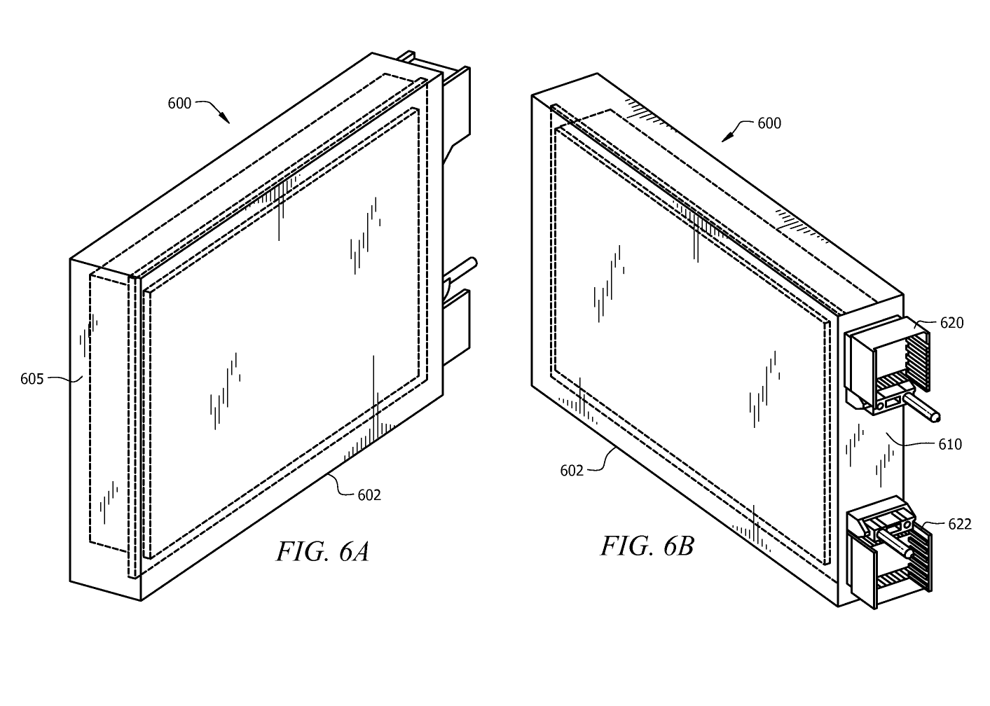

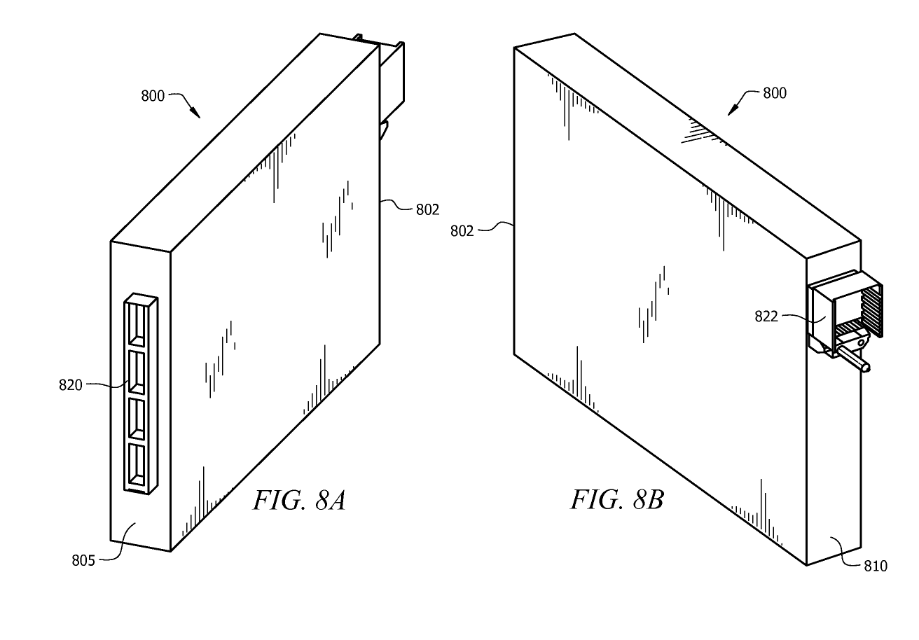

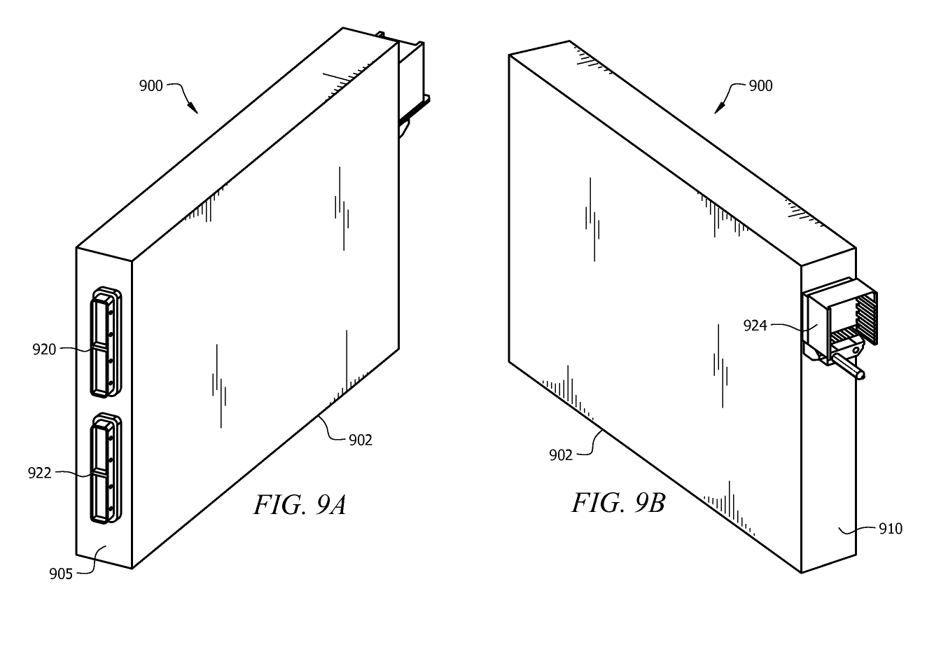

Elements and features of a management module 500 will be described in greater detail in association with the embodiment illustrated in FIGS. 5A and 5B. Elements and features of the interconnect module 600 will be described in greater detail in association with the embodiment illustrated in FIGS. 6A and 6B. Elements and features of a power supply module 112 will be described in greater detail in association with the embodiment illustrated in FIGS. 7A and 7B. Elements and features of a management module 500 will be described in greater detail in association with the embodiment illustrated in FIGS. 5A and 5B. Elements and features of a HIC 800 will be described in greater detail in association with the embodiment illustrated in FIGS. 8A and 8B. Elements and features of a TIC 900 will be described in greater detail in association with the embodiment illustrated in FIGS. 9A and 9B.

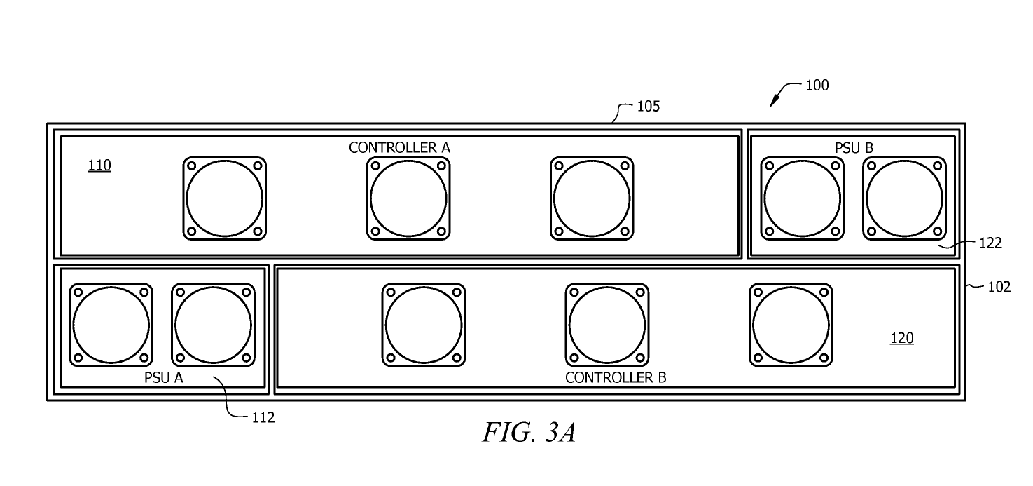

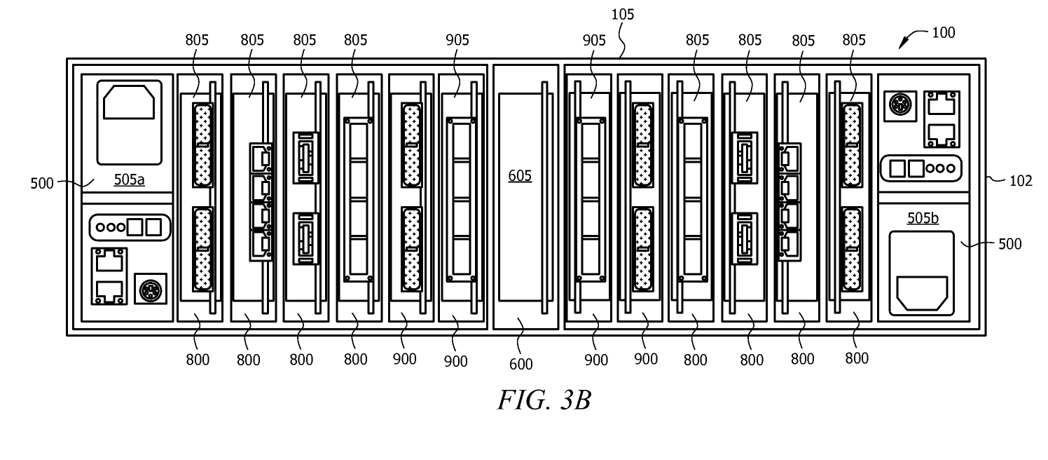

FIG. 3A is a front plan view of the storage controller 100 of FIG. 1. The first controller module 110, labeled Controller A in the front view is arranged above and partially offset from a second controller module 120. A first power supply module 112, labeled PSU A, is located below the first controller module 110 and to the left of the second controller module 120, which is labeled Controller B. A second power supply 122 or PSU B is located above the second controller module 120 and to the right of the first controller module 110.

FIG. 3B is a rear plan view of the storage controller 100 of FIG. 1. The leftmost management module 500 includes a second management panel 505a with the above described power and operator input/output interfaces. The leftmost management module 500 connects PSU A (i.e., the power supply module 112) to the Controller A (i.e., the controller module 110). The rightmost management module 500 includes a second management panel 505b with the above described power and operator input/output interfaces. The rightmost management module 500 connects PSU B (i.e., the power supply module 122) to the Controller B (i.e., the controller module 120). Note that the features and elements of the leftmost management module 500 and the rightmost management module 500 are identical. The respective management modules 500 are inverted vertically from each other to enable interconnectivity with the respective offset and overlapping controller modules.

The HICs 800 include a respective interface panel 805. The interface panel 805 includes a connector suited for coupling the HICs 800 to a host via a cable. The HICs 800 arranged to the left of the interconnect module 600 are coupled via respective connectors (hidden in the rear plan view) to the Controller A (i.e., the controller module 110). The HICs 800 arranged to the right of the interconnect module 600 are coupled via respective connectors (hidden in the rear plan view) to the Controller B (i.e., the controller module 120). The features and elements of the HICs 800 arranged to the left of the interconnect module 600 are identical to the correspondingly positioned HICs 800 arranged to the right of the interconnect module 600. The respective HICs 800 on opposing sides (left/right) of the interconnect module 600 are inverted vertically from each other to enable interconnectivity with the respective offset and overlapping controller modules.

The TICs 900 include a respective interface panel 905 that includes a connector suited for coupling the TICs 900 to a target via a cable. The TICs 900 arranged to the left of the interconnect module 600 are coupled via respective connectors (hidden in the rear plan view) to the Controller A (i.e., the controller module 110). The TICs 900 arranged to the right of the interconnect module 600 are coupled via respective connectors (hidden in the rear plan view) to the Controller B (i.e., the controller module 120). The features and elements of the TICs 900 arranged to the left of the interconnect module 600 are identical to the correspondingly positioned TICs 900 arranged to the right of the interconnect module 600. The respective TICs 900 on opposing sides (left/right) of the interconnect module 600 are inverted vertically from each other to enable interconnectivity with the respective offset and overlapping controller modules.

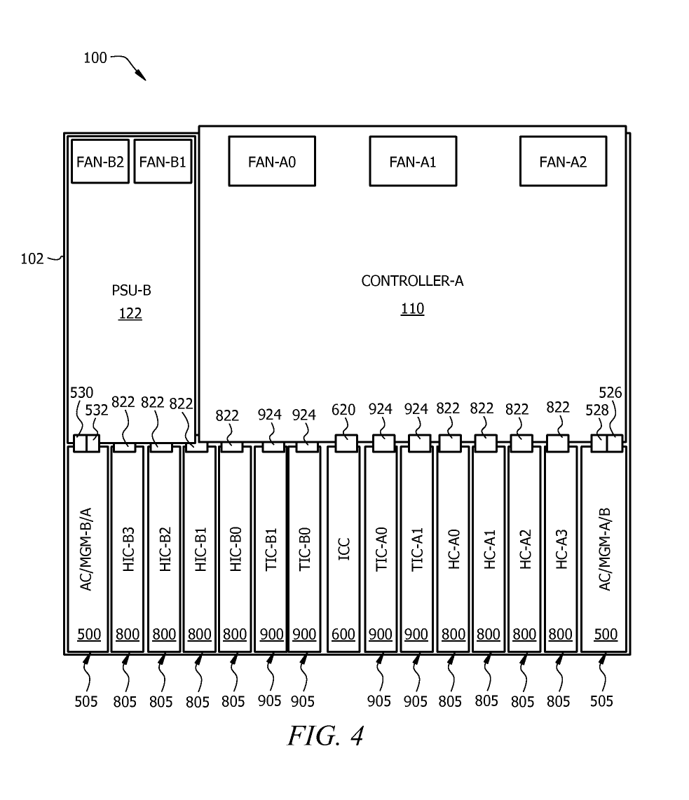

FIG. 4 is a top plan view of the storage controller 100 of FIG. 1 with the lid 105 removed. The Controller A (i.e., the controller module 110) and the PSU B (i.e., the power supply module 122) are observable in the top plan view of the storage controller 100 when the lid 105 is removed. The Controller B (i.e., the controller module 120) and the PSU A (i.e., the power supply module 112) are hidden from view with the PSU A entirely obscured by the Controller A and the Controller B obscured by both the Controller A and the PSU B. A series of connectors is arranged from left to right in the diagram to show the interconnections between the controller module 110 (the Controller A) and the leftmost management module 500, the HICs 800 (left of the interconnect module 600), the TICs 900 (left of the interconnect module) and the interconnect module 600. The leftmost management module 500 is connected to the Controller A by a direct-current power connector 526 and a signal connector 528. Each of the HICs 800 left of the interconnect module are connected to the Controller A by a connector 822. Each instance of the connector 822 and each instance of the connector 924 includes power and data connections for activating the corresponding HIC 800 or TIC 900. However, the storage controller 100 is not so limited as power and data signals could be separated in dedicated connectors for each function. The interconnect module 600 is connected to the Controller A by a connector 620. The connector 620 includes power and data connections for coupling the Controller A to the Controller B. The Controller B is electrically and physically connected to the interconnect module 600 via a connector 622, which is obscured in the top plan view.

The series of connectors further shows the interconnections between the PSU B and the rightmost management module 500, as well as the interconnections between the HICs 800 (right of the interconnect module 600), and the TICs 900 (right of the interconnect module 600) and the Controller B. For simplicity of illustration and description controller module and power supply module connectors are not shown. It should be understood that each of the illustrated connectors is actually one-half of a connector pair. The rightmost management module 500 is connected to the PSU B by a direct-current power connector 530 and an alternating-current power connector 532. Each of the HICs 800 right of the interconnect module 600 are connected to the Controller B by a connector 822. Each of the TICs 900 right of the interconnect module 600 are connected to the Controller B by a connector 924. Each instance of the connector 822 and each instance of the connector 924 includes power and data connections for activating the corresponding HIC 800 or TIC 900. However, the storage controller 100 is not so limited as power and data signals could be separated in dedicated connectors for each function.

FIGS. 5A-5B are front and rear perspective views respectively of an embodiment of a management module 500. The management module 500 is arranged within a housing 502. As illustrated in FIG. 5A, the second management panel 505 includes an AC power socket 520, an Ethernet interface 522, a RS-232 socket 524 and a display panel 525. The housing 502 contains one or more circuits or assemblies that support the Ethernet interface 522, the RS-232 socket 524 and the display panel 525. When the storage controller 100 is mounted in a rack, the second management panel 505 is observable from the rear of the storage controller 100. Accordingly, all cables to the management module 100 are accessible to an operator from the rear of the storage controller 100.

As shown in FIG. 5B, the first management panel 510 includes a DC power connector 526 and a signal connector 528 that enable the management module 500 to be coupled to one of the controller modules. The first management panel 510 further includes a DC power connector 530 and an AC power connector 532 that enable the management module 500 to be coupled to one of the power supply modules. In addition to the various connectors, the first management panel 510 also includes an alignment pin 540 that is arranged to closely fit within a corresponding alignment socket in a respective controller module.

FIGS. 6A-6B are front and rear perspective views respectively of an embodiment of an interconnect module 600. The interconnect module 600 is arranged within a housing 602. As illustrated in FIG. 6A, a blank panel 605 (i.e., a panel without connectors) is observable from the rear of the storage controller 100. The housing 602 contains one or more circuits or assemblies that support multiple data buses and a DC power bus.

As shown in FIG. 6B, the panel 610 includes a connector 620 and a connector 622. The connector 620 connects one side of the data buses and the power bus to the controller module 110 (i.e., Controller A). The connector 622 connects the opposing side of the data buses and the power bus to the controller module 120 (i.e., Controller B). The data buses will be further described in association with the description of the embodiment illustrated in FIG. 10. The DC power bus will be further described in association with the description of the embodiment illustrated in FIG. 11.

FIGS. 7A-7B are front and rear perspective views respectively of an embodiment of the power supply module 112 of FIG. 1. The power supply module 112 is arranged within a housing 702. As illustrated in FIG. 7A, a panel 705 includes first and second fans. The housing 702 contains one or more circuits or assemblies that convert an AC power supply input to one or more regulated DC voltages.

As shown in FIG. 7B, a panel 710 includes a DC power connector 720 and an

AC power connector 722. The DC power connector 720 couples the power supply module 112 to the DC power connector 530 on a respective management module 500. Similarly, the AC power connector 722 coupled the power supply module 112 to the AC power connector 532 on the respective management module 500.

FIGS. 8A-8B are front and rear perspective views respectively of an embodiment of a HIC 800 of FIG. 2. The HIC 800 is arranged within a housing 802. As illustrated in FIG. 8A, the panel 805 includes a connector 820. The connector 820 is arranged to physically and electrically connect to a corresponding connector (not shown) arranged on the end of a cable. A remote end of the cable is coupled to a corresponding host such as a computer. The housing 802 contains one or more circuits or assemblies that support data transfers between a respective controller module and the host. When the storage controller 100 is mounted in a rack, the panel 805 is observable from the rear of the storage controller 100. Accordingly, all cables to the HICs 800 are accessible to an operator from the rear of the storage controller 100. As shown in FIG. 8B, a panel 810, opposed to the panel 805, includes a connector 822 that provides power and data connections from a corresponding controller module.

FIGS. 9A-9B are front and rear perspective views respectively of an embodiment of a target input/output module 900 of FIG. 2. The TIC 900 is arranged within a housing 902. As illustrated in FIG. 9A, the panel 905 includes a first connector 920 and a second connector 922. The first connector 920 and the second connector 922 are arranged to physically and electrically connect to corresponding connectors (not shown) arranged on the end of cables. Remote ends of the cables are coupled to a corresponding target device such as a hard disk drive. The housing 902 contains one or more circuits or assemblies that support data transfers between a respective controller module and the target. When the storage controller 100 is mounted in a rack, the panel 905 is observable from the rear of the storage controller 100. Accordingly, all cables to the TICs 900 are accessible to an operator from the rear of the storage controller 100. As shown in FIG. 9B, a panel 910, opposed to the panel 905, includes a connector 924 that provides power and data connections from a corresponding controller module.

FIG. 10 is a functional block diagram illustrating an embodiment of data paths within the storage controller 100 of FIG. 1. As indicated above, each of the controller module 110 and the controller module 120 are similarly configured. Each of first and second processors 1020 can comprise a central processing unit (CPU) integrated circuit chip. For example, the processor chip can be of a type of CPU chip commonly used in embedded systems, such as any of those available from Intel Corporation of Santa Clara, Calif. Such processors have some features that facilitate RAID minoring operations, but are otherwise (i.e., substantially) general-purpose processors. Each of memories 1040 can comprise a group of one or more integrated circuit memory chips. For example, each of memories 1040 can comprise a group of three memory modules containing double-data-rate three synchronous dynamic random access memory (DDR3 SDRAM), which provide a high data transfer rate.

Data bus switches 1030 are devices that can be configured by loading configuration data from a suitable source, such as a serial electrically programmable read-only memory or EPROM (not shown). Each of the data bus switches 1030 can conform to a bus specification, such as the well-known PCIe or “Peripheral Component Interconnect—Express” specification. An example of a suitable PCIe switch that can be configured by loading data into it from, for example, a serial EPROM, is the ExpressLane™ PCI Express switch available from PLX Technology Inc. of Sunnyvale, Calif. as part number PEX8648.

Although the busses described herein can be of any suitable type, PCIe and similar bus technologies can provide some advantages over some previous bus technologies. While the older PCI or “Peripheral Component Interconnect” bus was a parallel data format bus that was primarily used for connecting computer peripheral device circuit cards to a computer motherboard, the PCIe bus is a versatile, high-bandwidth, serial I/O bus that lends itself to use throughout a computing device architecture. A PCIe bus provides a point-to-point connection, meaning that it does not share bus bandwidth but rather communicates directly with devices via a PCIe-compatible switch that directs data flow. The PCIe specification also provides bus scalability through a concept known as “lanes.” Under the PCIe specification, a PCIe bus can have up to 32 lanes (in power-of-two multiples, i.e., 1, 2, 4, 16 or 32), with the number of lanes being referred to as “x1” for a single lane, “x2” for a dual lane, etc. In the exemplary embodiment described herein, all PCIe busses can be, for example, x8 PCIe busses.

The above-described electronic devices can be electrically interconnected by bus-like circuit traces (i.e., metalized pathways on a circuit card), wires, or any other similar (physical, electrical pathway) interconnections of the types commonly utilized in circuit cards or other electronic assemblies. As persons skilled in the art are readily capable of providing suitable interconnections, they are not described in further detail herein and such details are not shown in the conceptualized depiction in FIGS. 10 and 11.

As illustrated in FIG. 10, a first data path is defined by the combination of data bus 1002, data bus 1000, and data bus 1004 and a second data path is defined by the combination of data bus 1012, data bus 1010, and data bus 1014. Although shown in FIG. 10 as unitary structures for purposes of clarity, each of the above-described interconnections or data busses can comprise multiple circuit traces or other electrical pathways, and can comprise multiple groups of such pathways. As described above, the physical and electrical connection between the data bus 1002 and the data bus 1000 as well as the physical and electrical connection between the data bus 1012 and the data bus 1010 is made via multiple circuits embodied within the connector 620 on the interconnect module 600. Similarly, the physical and electrical connection between the data bus 1004 and the data bus 1000 as well as the physical and electrical connection between the data bus 1014 and the data bus 1010 is made via multiple circuits embodied within the connector 622 on the interconnect module 600. The electrical connections enabled by the connector 620 and the connector 622 provide signal paths from the redundant PCIe switches 1030 in the controller module 110 via the interconnect module 600 to respective redundant PCIe switches in the controller module 120. The connection 1002 and the connection 1004 are coupled via conductive elements in the connector 620 and the connector 622 via the data bus 1000 in the interconnect module 600. Similarly, the connection 1012 and the connection 1014 are coupled via conductive elements in the connector 620 and the connector 622 via the data bus 1010 in the interconnect module 600. The connector 620 couples the interconnect module 600 to the controller module 110. The connector 622 couples the interconnect module 600 to the controller module 120.

The redundant PCIe switches 1030 in the controller module 110 are coupled by additional data busses to a respective pair of HICs 800 and a respective TIC 900. For example, the leftmost PCIe switch 1030 in the controller 110 is coupled by additional data busses to the two leftmost HICs 800 (to the left of the interconnect module 600) and the leftmost TIC 900 (to the left of the interconnect module 600) in addition to the above-described connection to the interconnect module 600. The rightmost PCIe switch 1030 in the controller 110 is coupled by additional data busses to the two rightmost HICs 800 (to the left of the interconnect module 600) and the rightmost TIC 900 (to the left of the interconnect module 600) in addition to the above-described connection to the interconnect module 600.

Similarly, the redundant PCIe switches 1030 in the controller module 120 are coupled by additional data busses to a respective pair of HICs 800 and a respective TIC 900. For example, the leftmost PCIe switch 1030 in the controller 120 is coupled by additional data busses to the two leftmost HICs 800 (to the right of the interconnect module 600) and the leftmost TIC 900 (to the right of the interconnect module 600) in addition to the above-described connection to the interconnect module 600. The rightmost PCIe switch 1030 in the controller 120 is coupled by additional data busses to the two rightmost HICs 800 (to the right of the interconnect module 600) and the rightmost TIC 900 (to the right of the interconnect module 600) in addition to the above-described connection to the interconnect module 600.

Data busses can be defined on these interconnections by the combination of the (physical) interconnections themselves with the effects of data bus protocols and other data bus characteristics or specifications. Data busses conforming to the PCIe specification can be defined, i.e., configured on the physical interconnections, by configuring the data bus switches 1030 in the respective controller modules. Depending upon the configuration data loaded into data bus switches 1030, the data bus switches 1030 can assume different data bus configurations on the same physical interconnections.

Although shown in FIG. 10 as unitary structures for purposes of clarity, each of the above-described interconnections or data busses can comprise multiple circuit traces or other electrical pathways, and can comprise multiple groups of such pathways. As described above, the physical and electrical connections between the data bus 1002 and the data bus 1000 as well as the physical and electrical connections between the data bus 1012 and the data bus 1010 are made via multiple circuits embodied within the connector 620 and the connector 622 on the interconnect module 600. Similarly, the physical and electrical connections between the data bus 1004 and the data bus 1000 as well as the physical and electrical connections between the data bus 1014 and the data bus 1010 are made via multiple circuits embodied within the connector 620 and the connector 622 on the interconnect module 600.

FIG. 11 is a block diagram illustrating an embodiment of power connections and direct-current buses within the storage controller 100 of FIG. 1. As illustrated in FIG. 11, a first AC power connection 1110 supplies AC power from the power management module 500 to the power supply module 122 (i.e. PSU B). The first AC power connection 1110 between the power supply module 122 and the management module 500 is made via multiple connections (i.e., conductors) within the connector 532 on the management module 500 and the connector 722 on the power supply module 122. A first DC power connection 1120 begins in the power supply module 122 and is routed through the management module 500 on its way to the controller module 120. The first DC power connection 1120 between the power supply module 122 and the management module 500 is made via multiple connections (i.e., conductors) within the connector 720 on the power supply module 122 and corresponding connections within the connector 530 on the management module 500. The first DC power connection 1120 between the management module 500 and the controller module 120 is made via multiple connections (i.e., conductors) within the connector 526 on the management module 500 and a corresponding connector on the controller module 120. At the controller module 120, the first DC power connection 1120 is coupled to a DC power bus 1132 by a series coupled diode. As illustrated in FIG. 11, the DC power bus 1132 provides DC power to each of the HICs 800 and the TICs 900 on the right side of the interconnect module 600.

A second AC power connection 1112 supplies AC power from the power management module 500b to the power supply module 112 (i.e., PSU A). The second AC power connection 1112 between the power supply module 112 and the management module 500 is made via multiple connections (i.e., conductors) within the connector 532 on the management module 500 and corresponding connections in the connector 722 on the power supply module 112. A second DC power connection 1122 begins in the power supply module 112 and is routed through the management module 500 on its way to the controller module 110. The second DC power connection 1122 between the power supply module 112 and the management module 500 is made via multiple connections (i.e., conductors) within the connector 720 on the power supply module 112 and corresponding connections within the connector 530 on the management module 500. The second DC power connection 1122 between the management module 500 and the controller module 110 is made via multiple connections (i.e., conductors) within the connector 526 on the management module 500 and a corresponding connector on the controller module 110. At the controller module 110, the second DC power connection 1122 is coupled to a DC power bus 1130 by a series coupled diode. The DC power bus 1130 provides DC power to each of the HICs 800 and the TICs 900 on the left side of the interconnect module 600.

As further indicated in FIG. 11, a DC power path is defined by the combination of a DC power connection 1102, a DC power bus 1100, and a DC power connection 1104. The DC power connection 1102 couples the DC power bus 1130 to the DC power bus 1100 in the interconnect module 600. The DC power connection 1104 couples the DC power bus 1132 to the DC power bus 1100 in the interconnect module 600. When the interconnect module 600 is coupled to the controller modules 110, 120, DC power is available to each of the respective controller modules 110, 120 from both management modules 500. When the interconnect module 600 is coupled to the controller module 110 and the controller module 120, redundant power connections are provided to the controller modules 110, 120, the HICs 800, and the TICs 900. In the event of a power failure in one of the two management modules, the DC power connection provided in the interconnect module 600 will provide power to both controller modules 110, 120 and to both sets of HICs 800 and TICs 900.

When the interconnect module 600 is removed, i.e., by decoupling the connector 620 and decoupling the connector 622, from the storage controller 100, each controller module 110, 120, HIC 800, and TIC 900 set is independently powered by the respective power supply module/management module pair. A DC power failure in one of the power supply module/management module pairs will result in reduced functionality of the storage controller 100, as DC power will be provided to only one of the sets of HICs 800 and TICs 900 via the powered controller module. The HICs 800 and TICs 900 coupled to the unpowered controller module will not be powered on.

FIG. 12 is a partial front perspective view of an embodiment of the storage controller 100 of FIG. 1. The partial front view shows the storage controller 100 with the power supply module 112, the power supply module 122, and the controller module 110 removed. The partial front view shows features and elements of the management module 500, the HICs 800 and the TICs 900 in registration with the remaining controller module 120. That is, the partial front view in FIG. 12 shows details of the interconnections between the controller module 120 and the various HICs 800, TICs 900, the interconnect module 600 and the management module 500. The leftmost insert shows an example embodiment of the connector 622 provided on the panel 610 of the interconnect module 600 to electrically and physically connect the data busses 1000 and 1010 as well as DC power bus 1100 to the controller module 120 via a corresponding connector coupled to the controller module 120. The connector 622 and the corresponding connector coupled to the controller module 120 (not shown in the insert) are an orthogonally arranged connector pair. In accordance with the rightmost insert, the various HICs 800 and TICs 900 are electrically and physically coupled to the controller module 120 via an orthogonally arranged connector pair. Hereinafter, an orthogonally arranged connector pair will be referred to as an orthogonal connector pair assembly.

The orthogonal connector pair assembly includes a first coupler 1210, a second coupler 1212, a first connector 1220, and a second connector 1222. The first coupler is arranged on a printed circuit assembly 1202 within the controller module 120. The printed circuit assembly 1202 or circuit card is substantially parallel to bottom panel and the lid 105 of the housing 102. The second coupler 1212 is arranged on a printed circuit assembly 1204 within the corresponding HIC 800 or TIC 900. The printed circuit assembly 1204 is substantially parallel to the side panels of the housing 102. As a result, the printed circuit assembly 1204 is substantially orthogonal to the circuit assembly 1202. As described above, the first connector 1220 and the second connector 1222 include corresponding conductors to support a data bus and to provide DC power to the respective HIC 800 or TIC 900. An example of a suitable connector 1222 that can be used to couple multiple conductors on a printed circuit assembly 1204 within a HIC 800 or a TIC 900 is part number 76850-0208 available from Molex of Lisle, Illinois, U.S.A. An example of a suitable connector 1220 that can be used to couple multiple conductors on a printed circuit assembly 1202 within a controller module is part number 76730-0680 also available from Molex of Lisle, Illinois, U.S.A.

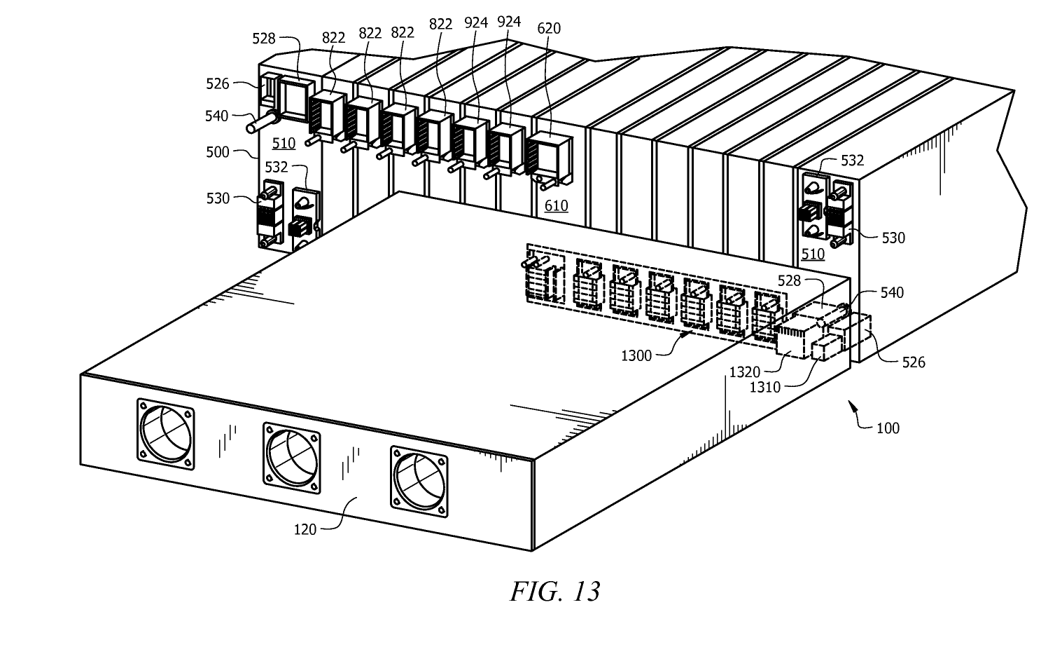

FIG. 13 is a partial front perspective view of an alternative embodiment of the storage controller 100 of FIG. 1. In the alternative embodiment, the power supply module 112, the power supply module 122, and the controller module 110 are removed to show features and elements of the management module 500, the HICs 800 and the TICs 900 in registration with the remaining controller module 120. In the alternative embodiment, one or more of the connectors provided on the controller module 120 are arranged on a riser 1300 that extends upwardly from a socket (not shown) within the controller module 120. The partial front perspective view illustrated in FIG. 13 further reveals a connector 1310 that couples conductors within the same to conductors within the DC power connector 526 (on the management module) and a connector 1320 that couples conductors within the same to conductors within the signal connector 528 (on the management module 500).

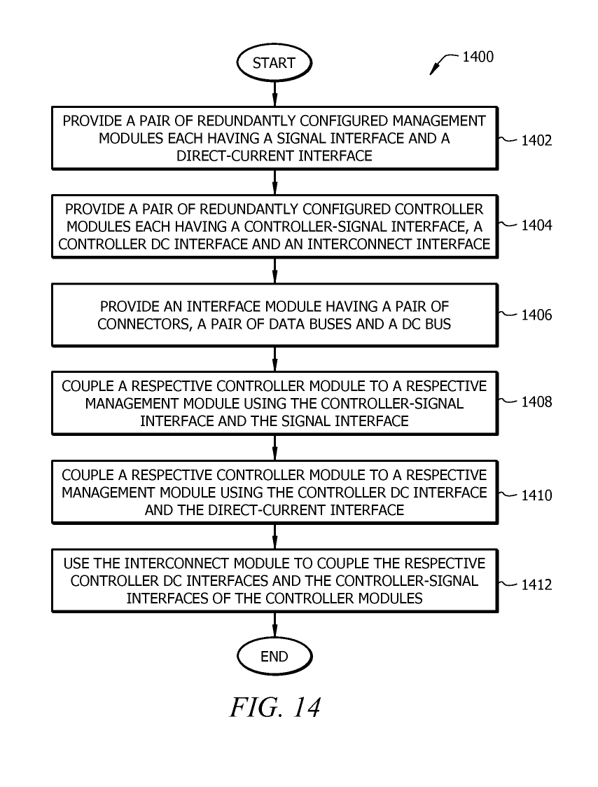

FIG. 14 is a flow diagram illustrating an embodiment of a method 1400 for providing a hot-swappable and field-serviceable storage-controller. The flow diagram of FIG. 14 shows a method for arranging modules or subsystems of a storage controller.

The method 1400 begins with block 1402 where a pair of redundantly configured management modules each having a management-signal interface and a management direct-current interface are provided. In block 1404, a pair of redundantly configured controller modules each having a controller-signal interface, a controller direct-current interface, and an interconnect interface are provided. The interconnect interface has a data bus connection and a direct-current bus connection. In block 1406, an interconnect module comprising a pair of connectors, a pair of data buses, and a pair of direct-current buses is provided. In block 1408, a respective controller module is coupled to a respective management module via the controller signal interface and the management-signal interface. In block 1410, a respective controller module is coupled to a respective management module via the controller direct-current interface and the management direct-current interface. In block 1412, the interconnect module is used to couple the respective data bus connection and the respective direct-current bus connection of the redundantly configured controller modules. By connecting the respective DC power busses of the of the controller modules together, both controller modules can remain powered on when a power supply or a management module fails. Conversely, if the interconnect module 600 needs to be removed, the controller modules 110, 120 can receive power via respective dedicated power connections to an associated management module. As described above in association with FIGS. 3A, 3B, 4, and 10-13, HICs 800 and TICs 900 are also coupled to respective controller modules to provide a redundant storage controller 100. Installed HICs 800 and TICs 900 receive power and data from the coupled controller module.

Exemplary steps for providing a hot-swappable and field-serviceable storage-controller are illustrated in FIG. 14. The particular sequence of the steps or functions in blocks 1402 through 1410 is presented for illustration. It should be understood that the order of the steps or functions in blocks 1402 through 1410 can be performed in any other suitable order or modified in a suitable manner to arrange management modules and controller modules to align respective connectors for coupling via the interconnect module.

While various embodiments of the modular and redundant storage controller and a method for providing a hot-swappable and field-serviceable storage-controller have been described, it will be apparent to those of ordinary skill in the art that many more embodiments and implementations are possible that are within the scope of this disclosure. Accordingly, the described storage controller and method for providing a hot-swappable and field-serviceable storage controller are not to be restricted or otherwise limited except in light of the attached claims and their equivalents.

What is claimed is:

1. A modular and redundant storage controller system, comprising:
a pair of redundantly configured management modules each comprising a first management panel and a second management panel, the second management panel opposed to the first management panel, the first management panel comprising a management-signal interface and a management direct-current interface;
a pair of redundantly configured controller modules each comprising an interface panel having a controller-signal interface, a controller direct-current interface, and an interconnect-module interface, the controller-signal interface arranged to electrically couple a respective controller module to a respective management module via the management-signal interface, the controller direct-current interface arranged to electrically couple a respective controller module to a respective management module via the management direct-current interface; and
an interconnect module comprising a pair of connectors arranged to electrically couple the pair of redundantly configured controller modules via the respective interconnect-module interfaces, the interconnect module coupling respective direct-current busses in the pair of redundantly configured controller modules to each other.

2. The storage controller system of claim 1, wherein the pair of connectors each belongs to a respective orthogonal connector pair.

3. The storage controller system of claim 1, wherein the pair of redundantly configured controller modules each comprises a respective riser.

4. The storage controller system of claim 1, wherein the pair of redundantly configured management modules each comprises a respective alignment element along the first management panel.

5. The storage controller system of claim 4, wherein the pair of redundantly configured controller modules each comprises a respective alignment feature arranged to fix the relative position of the first management panel with respect to the interface panel.

6. The storage controller system of claim 1, wherein the pair of redundantly configured controller modules each further comprises a plurality of input/output interfaces.

7. The storage controller system of claim 6, wherein the plurality of input/output interfaces is coupled to a respective interface module by a respective orthogonal connector pair.

8. The storage controller system of claim 6, wherein the plurality of input/output interfaces are arranged on a riser.

9. The storage controller system of claim 1, wherein the first management panel of each of the redundantly configured management modules further comprises a first management/power supply interface and a second management/power supply interface.

10. The storage controller system of claim 9, wherein the first management/power supply interface comprises an alternating-current supply and the second management/power supply interface comprises a direct-current supply.

11. The storage controller system of claim 1, wherein the second management panel comprises an alternating-current power-supply socket, a serial signal-interface port, and an Ethernet-interface port.

12. The storage controller system of claim 1, wherein the interconnect module further comprises a first data bus and a second data bus.

13. The storage controller system of claim 1, wherein when the interconnect module is electrically decoupled from the system, a direct-current bus from each of the respective management modules provides electrical energy to a corresponding controller module.

14. A method for providing a hot-swappable and field-serviceable storage-controller system, comprising:
providing a pair of redundantly configured management modules each comprising a management-signal interface and a management direct-current interface;
providing a pair of redundantly configured controller modules each comprising a controller-signal interface, a controller direct-current interface, and an interconnect interface, the interconnect interface having a data bus connection and a direct-current bus connection;
providing an interconnect module comprising a pair of connectors, a pair of data buses, and a pair of direct-current buses;
coupling a respective controller module to a respective management module via the controller signal interface and the management-signal interface;
coupling a respective controller module to a respective management module via the controller direct-current interface and the management direct-current interface; and
using the interconnect module to couple the respective data bus connection and the respective direct-current bus connection of the redundantly configured controller modules.

15. The method of claim 14, wherein using the interconnect module to couple the respective data bus connection and the respective direct-current bus connection further comprises using a first orthogonal connector pair.

16. The method of claim 14, further comprising coupling an input/output interface on an input/output module to a member of the pair of redundantly configured controller modules.

17. The method of claim 16, wherein coupling an input/output interface on an input/output module to a member of the pair of redundantly configured controller modules further comprises using a second orthogonal connector pair.

18. The method of claim 14, wherein providing a pair of redundantly configured controller modules further comprises arranging connectors on a riser.

19. The method of claim 14, further comprising arranging the pair of redundantly configured controller modules in an offset and overlapping configuration.

20. The method of claim 19, further comprising locating the interconnect module in a region where the pair of redundantly configured controller modules overlap.
